(19) United States
(12) Patent Application Publication
(10) Pub. No.: US 2006/0165030 A1
(43) Pub. Date: Jul. 27, 2006

(54) Method of and system for transmitting a mobile agent for instruction execution

(76) Inventors: Brian J. Fox, Santa Barbara, CA (US); Jonathan Lixing Lei, Goleta, CA (US)

Correspondence Address: MCDERMOTT WILL & EMERY LLP;ATTN: INTELLECTUAL PROPERTY DEPTARTMENT, 28 STATE STREET, BOSTON, MA, 02109, US

(21) Appl. No.: 11/006,287

(22) Filed: Dec. 7, 2004

(51) Int. Cl. H04Q 7/00

(52) U.S. Cl. 370/328

(57) ABSTRACT

A method of executing programmable instructions includes receiving at a device a mobile agent from a mobile agent dispatching device. The mobile agent includes a state of a virtual machine. The method also includes executing at the device one or more instructions identified by the mobile agent, thereby changing the state of the virtual machine.

### TECHNICAL FIELD

This disclosure relates to transmitting a mobile agent for executing programmable instructions and, more particularly, to transmitting a virtual machine in a mobile agent to assist instruction execution.

### BACKGROUND

As hardwire and wireless communication networks become more imbedded in society, expectancy increases of always being able to contact a particular person at any time. Often business people use a collection of telecommunication products to contact one another and to remain in contact. By carrying cellular telephones, pagers, personal digital assistances (PDA) and the like, a person can be mobile while still remaining in contact for important business and personal messages.

Although, while a person may own a number of wireless devices, due to personal preferences or idiosyncrasies, only one or two of the devices may actually be used by the person at any given time. Due to this personal preference, an important message may not be received in a timely manner or possibly not received at all. For example, a business person may prefer to monitor his or her PDA as opposed to their cellular phone or pager. Due to this preference, the person may tend to always keep his or her PDA handy and tend to leave their cell phone and pager in their office or home. Since other people may not be aware of this personal preference, they may attempt to make contact through the cellular phone and pager before attempting to send a message to the PDA during an emergency. While this delay may not have consequences in some instances, scenarios can be imagined in which such a delay is dire. A school may need to contact a parent in the event of an medical emergency and direct them to a particular hospital. By not being aware of the parent's preference to use a PDA, precious time may be lost if the school follows a procedure of only calling and leaving messages on home telephones and cellular phones.

### SUMMARY OF THE INVENTION

In one implementation, a method of executing programmable instructions includes receiving at a device a mobile agent from a mobile agent dispatching device. The mobile agent includes a state of a virtual machine. The method also includes executing at the device, one or more instructions identified by the mobile agent, thereby changing the state of the virtual machine.

One or more of the following features may also be included. The method may further include sending the mobile agent to another device such as the mobile agent dispatching device or a different device. The mobile agent sent to the second device represents the changed state of the virtual machine. The mobile agent may be sent to the second device after a timeout period expires at the first device.

In another implementation, a system for executing programmable instructions includes a mobile agent dispatching device for sending a mobile agent to another device. The mobile agent includes a state of a virtual machine and one or more instructions that when executed at the device change the state of the virtual machine.

One or more of the following features may also be included. The system may further include another device for receiving the mobile agent that is sent from the first device. The mobile agent received at the second device represents the changed state of the virtual machine. The mobile dispatching device or either device in the system may include a computer system, a PDA, a cellular telephone, or other similar type of device. The state of the virtual machine, which may be represented by a string, may include information that represents the contents of a register, stack, or other similar data storing structure. The mobile agent may also include segments that represent data or executable instructions (e.g., bytecode instructions).

In another implementation, a computer program product residing on a computer readable medium having a plurality of instructions stored thereon which, when executed by the processor, cause that processor to receive at a device a mobile agent from a mobile agent dispatching device. The mobile agent includes a state of a virtual machine. Further the processor executes at the device one or more instructions that are identified by the mobile agent and change the state of the virtual machine.

One or more of the following features may also be included. The mobile agent, which represents the changed state of the virtual machine may be sent to a second device. Sending of the mobile agent may be initiated by a timeout period expiring. The changed state of the virtual machine may be represented by a string that is inserted into the mobile agent.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a block diagram depicting a network of wireless and hardwire communication devices.

FIG. 2 depicts mobile agents transmitting though a portion of the communication network.

FIG. 3 depicts a message and input request being presented on three different communication devices.

FIG. 4 is a block diagram that represents a mobile agent that stores the state of a virtual machine.

FIG. 5 is an exemplary listing of code that represents information, including a state of a virtual machine, stored in a mobile agent.

FIG. 6 is a flow chart that represents interactions between a mobile agent and a recipient communication device.

### DETAILED DESCRIPTION OF THE PREFERRED EMBODIMENTS

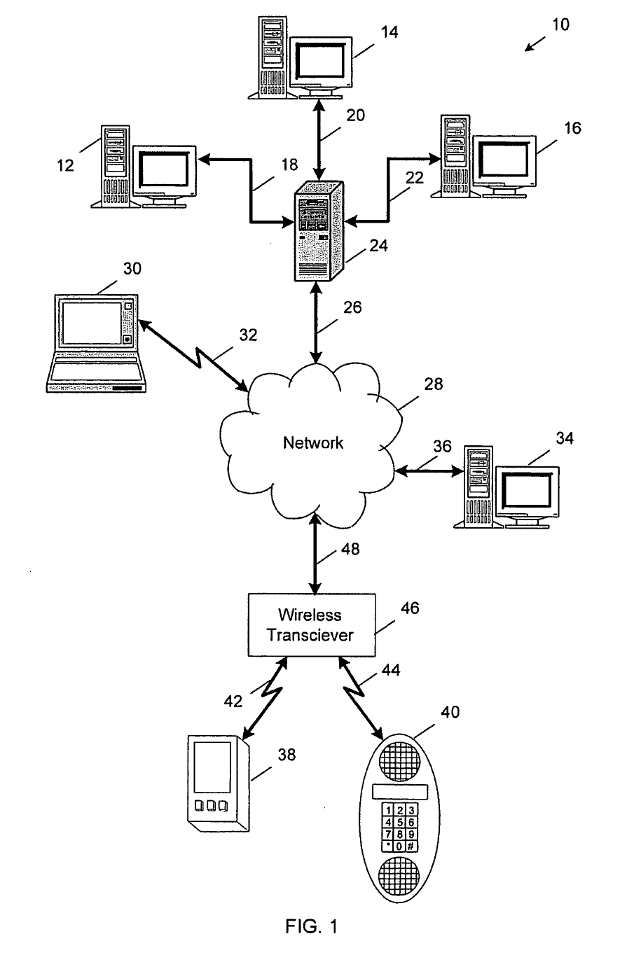

Referring to FIG. 1, a communication system 10 includes a variety of communication devices are capable of sending and receiving information over hard wire and wireless links. For example, a group of computer systems 12-16 individually connect over respective hardwire links 18-22 to a server 24. By establishing these connections, server 24 operates as a gateway for electronically passing information (e.g., email messages, data files, etc.) among computer systems 12-16. Server 24 also connects over a hardwire link 26 to a network 28 (e.g., the Internet, a wide area network, a local area network, etc.) so that information may be passed among one or more of computer systems 12-16 and other remotely-located communication devices. For example, messages and information may be passed between a laptop 30, via a wireless link 32, and each device that is connected directly or indirectly to network 28. A computer system 34, which may be located at a residence, is connected through a hardwire link 36 so that information may be sent from and received at the residence.

Along with connecting computer systems to network 28 by a hardwire or wireless link (or a combination of hardwire and wireless links), other types of communication devices may be linked to network 28 for information sharing. For example, a PDA 38 and a cellular phone 40 may connect to network 28 by establishing respective wireless links 42, 44 with a wireless transceiver 46 that is connected to network 28 through a hardwire link 48. Similar to server 24, wireless transceiver 46 may provide a gateway connected wireless devices (e.g., PDA 38, cell phone 40, etc.).

By providing such interconnectivity among the devices, information may be broadcast from one device to all of the other connected devices. For example, a message that includes text and or graphics may be broadcast from computer system 12 to each device in communication system 10. Information may also be selectively transmitted to particular devices or groups of devices. For example, a user of computer system 12 may want to send a message only to the particular person that uses computer system 34, PDA 38, and cell phone 40. Additionally, due to the personal preferences of the recipient, the user of computer system 12 may want the message to travel between the devices in a particular sequence. For example, the message may be first directed to the device (e.g., computer system 34) most frequently used by the recipient. Then, if the recipient is not currently using that device, the message is sent to the recipient's next most frequently used device (e.g., PDA 38). Finally, if there is still no indication that the recipient has received the message, the message is passed to the device (e.g., cell phone 40) least used by the recipient. Since the message is being passed to different types of communication devices, a platform-independent message that is compatible with each device is transmitted through communication system 10.

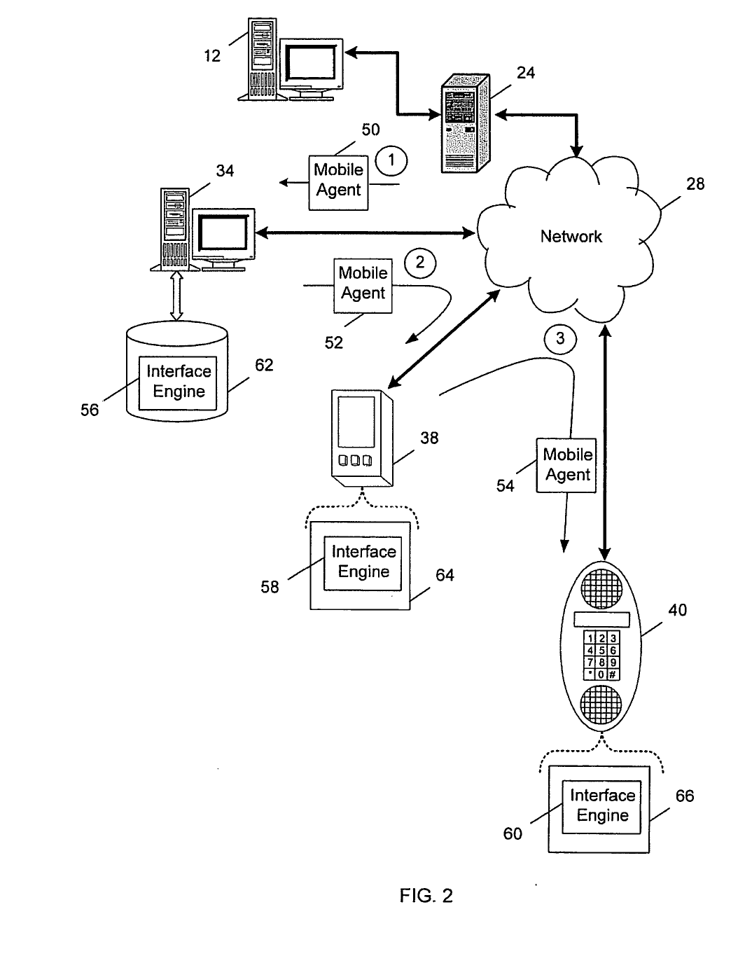

Referring to FIG. 2, a portion of communication system 10 (shown in FIG. 1) is presented to demonstrate transmitting a platform-independent message to devices in a particular sequence. In this example, the message originates at computer system 12 and is first sent to computer system 34, which is located at the recipient's residence, by way of server 24 and network 28. This first leg of the transmission sequence is identified as pathway “1”. Based on the message reception at computer system 34 (e.g., the recipient is not present to receive the message), the message may be transmitted to the next most frequently used recipient device. For example, based on the recipient not interacting with computer system 34, the message may then be sent to PDA 38 (i.e., identified as pathway “2”). Simultaneously, or due to no recipient interactions with PDA 38, the message may also be sent to the less frequently used recipient device (e.g., cell phone 40) as identified by pathway “3”). While this example presents relatively simple transmission paths for message travel, one skilled in the art could conceive of rather complex transmission paths that include communication system 10 and other systems not shown. Additionally, while exemplary communication system 10 includes relatively few devices, in other arrangements a communication system may include a large number of devices (e.g., a satellite based communication system) and be capable of transmitting many messages.

To pass information (e.g., messages) among the devices in communication system 10, mobile agents are dispatched from and received by the devices. Continuing the message-sending scenario discussed above, a mobile agent 50 (that stores the message) is produced by and dispatched from computer system 12. Following pathway “1”, mobile agent 50 is received by computer system 34. Then as mentioned, based on lack of user interaction with computer system 34, a mobile agent 52 (a modified version of mobile agent 50) is sent to one or more other devices (e.g., PDA 38). Furthermore, additional mobile agents may be sent throughout communication system 10 to provide the message to the intended recipient. For example, if no user interaction occurs response at PDA 38, mobile agent 54 (a modified version of mobile agent 52) is sent to cell phone 40 over pathway “3”.

Typically mobile agents 50-54 have a transitory presence and travel in a self-contained fashion such that when they are sent from a device, substantially no trace of the agent remains on the device. For example, once mobile agent 50 is transmitted from computer system 12 to computer system 34, little or no trace of the agent remains on computer system 12. Mobile agents such as mobile agent 50 are relatively small software objects that move from one device to the next to execute one or more instructions (or programs) that are included in the agent. Some mobile agent operate in a “Fire-and-forget” mode in which the agent is transmitted to a device and is no longer under the control of the device from which it was dispatched. By making decisions and acting independently on a recipient device, the mobile agent reduces the workload of the dispatching device. For example, by interacting with users at a device such as computer system 34, processing power and clock cycles of the agent dispatching device (e.g., computer system 12) are conserved for other local operations.

Along with moving executable code, mobile agent 50 includes other types of information. Data such as strings, integers, arrays, data structures, and the like may be inserted into the mobile agent to assist with the execution of one or more instructions at the recipient device. For example, data may be inserted into mobile agent 50 by computer system 12 to assist with subroutine calls. Furthermore, data may be inserted into a mobile agent (e.g., mobile agent 52) by one device (e.g., computer system 34) to direct the mobile agent to another device (e.g., PDA 38). A mobile agent may also be received by one device and held for a period of time without executing any instructions associated with the mobile agent. After the time period expires, the mobile agent may be transmitted to one or more devices. Additionally, the mobile agent may be sent to the same device that held the mobile agent for the time period.

Information that provides a unique identifier may also be included in each mobile agent. For example, a unique string (or array) of alpha-numeric characters may included to uniquely identify each agent. Based on these identifiers, particular operations may be initiated by a recipient device. For example, based on the unique identification of a newly received mobile agent, the recipient device may delete one or more previously received mobile agents. By performing such as operation, only the most recently received information is used for executing instructions.

Each of the mobile agents (e.g. mobile 50, 52, and 54) also include data that represents the operational state of a virtual machine that is also used during instruction execution. In general, a virtual machine is a piece of software that emulates a hardware device (e.g., a computer system, central processing unit, etc.) with a particular architecture by including data that represents portions of the emulated hardware. For example, a virtual machine may include data that represents the state of registers (e.g., a program counter, etc.) and stacks used by a processor. By including this state information, as the mobile agent moves among the devices in a communication system, the recipient device can access and use the stored data (e.g., register content, stack content, etc.) in conjuncture its own hardware (e.g., processors, memory, etc.) to execute instructions. Also, by sending the current state of the virtual machine in a mobile agent, instructions are not repeatedly executed at each recipient device to place the virtual machine in a particular state. For example, since the virtual machine stored in mobile agent 52 reflects the instructions executed at computer system 34, instructions are not re-executed at PDA 38 to account for the operations performed at computer system 34. Thus, clock cycles and processing power are not wasted by repeatedly executing instructions.

As operations are executed at different devices (e.g., computer system 34, PDA 38, cell phone 40), the state of the virtual machine correspondingly changes. To account for these changes information is stored in the mobile agent. For example, when received by computer system 34, mobile agent 50 stores the state (e.g., register content, stack content, etc.) of a virtual machine. As instructions are executed on computer system 34, the contents of its registers and stacks change. To reflect these changes the virtual machine state is updated in the mobile agent. Mobile agent 52 represents these changes and is an updated version of mobile agent 50. By storing the updated state of the virtual machine, mobile agent 52 may be directed by to one or more other devices in communication system 10. Mobile agent 52 may also be directed to the same device that updated the virtual machine. By directing the mobile agent to the same device, operations may be re-executed using the updated state of the virtual machine. In this particular example, after directing mobile agent 52 to PDA 38, the state of the virtual machine is again altered by operations executed on PDA 38. Based on these executions, the state of the virtual machine changes with respect to the state stored in mobile agent 52. Mobile agent 54 (a modified version of mobile agent 52) represents these latest changes to the virtual machine state and provides this updated virtual machine to the next recipient device (e.g., cell phone 40).

Each of the mobile agents 50-54 may be received by any type of device in communication system 10 independent of platform type. So, while mobile agent 50 may be directed from computer system 12 to computer system 34, in other arrangements mobile agent 50 may be directed to one or more other types of devices (e.g., PDA 38, cell phone 40, laptop 30, etc.). To receive a platform-independent mobile agent (e.g., mobile agent 50) each device in communication system 10 executes a respective interface engine 56-60 that reside in memory at each device. In particular, interface engine 56 is stored in a storage device 62 (e.g., hard drive, CD-ROM, etc.) that is in communication with computer system 34. Interface engine 56 can then be loaded in memory (e.g., random access memory) for executing on computer system 34. Similarly, PDA 38 and cell phone 40 respectively include memories 64, 66 for executing interface engines 58 and 60.

Along with accessing and retrieving virtual machine states (e.g., register content, stack content, etc.) stored in a received mobile agent, interface engines 56-60 also assist in updating the virtual machines to reflect states changes due to operations executed on the device (e.g., computer system 34, PDA 38, cell phone 40, etc.) where the engine resides. Interface engines 56-60 also interrogate the respective device where engine resides to determine the capabilities and functionality of the device. For example, interface engine 56 determines what particular software packages (e.g., Internet browser, email system, etc.) reside on and may be executed by computer system 34. Additionally interface engine 56 may determine the location and pathway to executable files and commands associated with the software packages. By determining their locations and pathways, interface engine 56 can initiate execution of the software packages for performing particular functions (e.g., execute the Internet browser to initiate an Internet search).

The following example is provided to demonstrate the mobility and adaptability of the platform independent mobile agents and the stored virtual machines. In this example, communication system 10 is used for alerting government officials such as a town fire marshal to emergency information. However, communication system 10 may be used for various applications. For example, the system may be incorporated into a healthcare system for paging doctors and nurses in the event of an emergency. By forwarding information such as contact information, communication system 10 may be used by salespersons to pass ‘hot’ leads to one another. Communication system 10 may also be used to track down particular people such as a service representative for responding to a customer request. Furthermore, the system may be used to present information to a series of individuals. For example, by sequentially passing information to a series of individuals, the system may be incorporated into a multi-person approval system for compliance applications.

In this example, computer system 12 is located at a city hall and serves as a nerve center that distributes emergency information to appropriate city officials and employees. In this example city hall has been alerted to a house fire and computer system 12 is used to dispatch a message to a fire marshal who is currently off duty. Based on information stored in computer system 12, personnel at city hall determine that the fire marshal typically checks his home computer (i.e., computer system 34) for alerts and messages. Less frequently the fire marshal checks his PDA 38 and his cell phone 40 for emergency messages. Based on this information an emergency message is stored in mobile agent 50 and the agent is dispatched from computer system 12 and sent via server 24 and network 28 to computer system 34. Upon arriving at computer system 34, mobile agent 50 is detected by interface engine 56 and the virtual machine included in the agent is accessed e.g., to retrieve register and stack contents from the virtual machine.

Executable instructions are also retrieved from mobile agent 50. In conjunction with interface engine 56, the instructions are interpreted and executed so that an alert message is presented on computer system 34. A visual message may be displayed on a monitor included in computer system 34. Also, if interface engine 56 determined that computer system 34 is capable of producing audio signals (e.g., includes an sound card), executable instructions in mobile agent 50 for producing an audible tone are interpreted and executed as directed by interface engine 56.

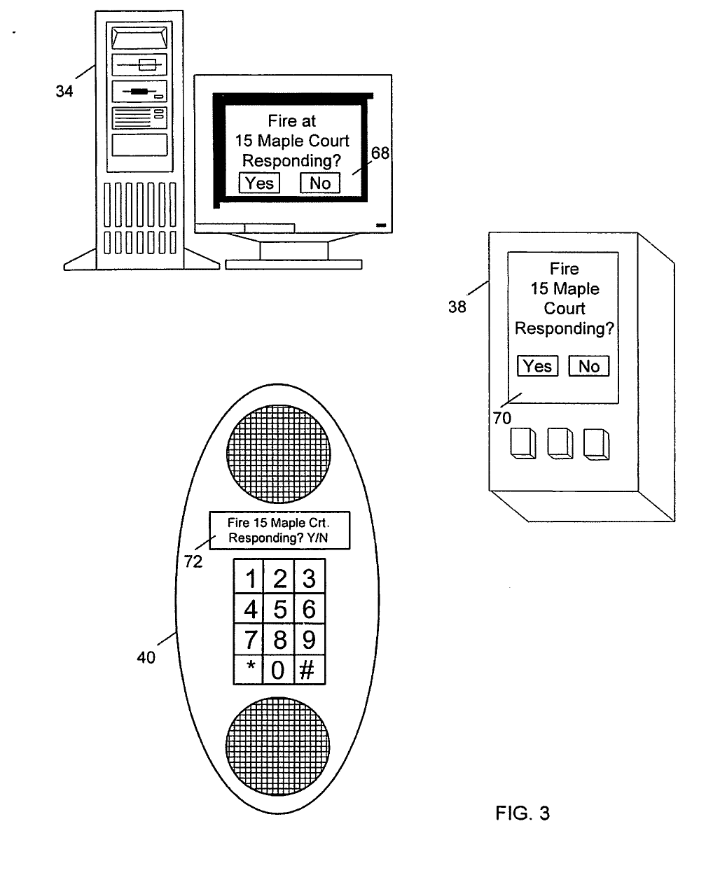

Referring to FIG. 3, a message 68 is displayed on computer system 34 that requires user input to acknowledge the message. In this example, an input device (e.g., mouse keyboard, etc.) is used by the user to select whether he or she is going to respond to the fire at the displayed location. Regardless of which selection is made, the state of the virtual machine in mobile agent 50 is updated to reflect the user selection. Once updated, mobile agent 50 may be sent back to computer system 12 to alert city hall to the intention of the fire marshal.

In this example, after presenting message 68 for a particular time period, a time out occurs and mobile agent 50 is updated to reflect the lack of user interaction. For example, after two minutes, if the fire marshal has not made a selection, an assumption is made that the he or she is not currently using computer system 34. An updated mobile agent (e.g., mobile agent 52) is then dispatched to another device as identified by information stored in mobile agent 50. The updated mobile agent may be sent to the same device to re-execute operations to determine is the fire marshal is now using device (e.g., computer system 34). Here mobile agent 52 is directed to PDA 38 to continue attempting to alert the fire marshal. Similar to interface engine 56 in computer system 34, interface engine 58 interrogates PDA 38 to determine its functionality and capabilities for assisting in executing instructions. Based on information associated with the functionality along with capabilities, along with instructions in mobile agent 52, PDA 38 displays an alert message 70 that includes the selections that were displayed in alert message 68.

Similar to computer system 34, the message presented on PDA 38 times-out after a period as specified by data included in mobile agent 52. If a selection is entered into PDA 38, the contents of the virtual machine is updated to account for the selection and may be sent back to computer system 12 to alert city hall of the selection. Also, other mobile agents may be sent throughout communication system 10 from PDA 38 to disseminate the entered selection. For example PDA 38 may also send a mobile agent to computer system 34 to provide the selection to people at the fire marshal's residence.

In this example, if a time-out occurs while PDA 38 displays alert message 70, PDA 38 updates the mobile agent (represented as mobile agent 54) to reflect that no selection has been made and sends mobile agent 54 to the next device associated with the fire marshal. Here, cell phone 40 is the least frequently used device by the fire marshal and mobile agent 54 is sent from PDA 30 to this device. Similar to the previous two recipient devices, interface engine 60 assists in accessing the virtual machine stored in mobile agent 54. Additionally, interface engine 60 assists in interpreting and executing instructions included in mobile agent 54 to present an alert message 72 on cell phone 40. Along with the visual alert message 72, an audible alert may be initiated from the instructions included in mobile agent 54.

In this particular example mobile agents were passed one at a time among a particular group of devices in communication system 10. However, multiple mobile agents may simultaneously propagate through system 10 to one or more devices. Also, in this example telecommunication devices were used to dispatch and receive the mobile agents. However, other similar types of electronic devices may be incorporated into a system for passing mobile agents. For example one or more microprocessors may form a communication system and each microprocessor or different portions of each microprocessor may be defined as a device that passes mobile agents. Furthermore, by including a virtual machine in each mobile agent passed throughout the system, processing time at each device may be reduced since the current state of the virtual machine is provided to a recipient device without instructions being repeatedly executed.

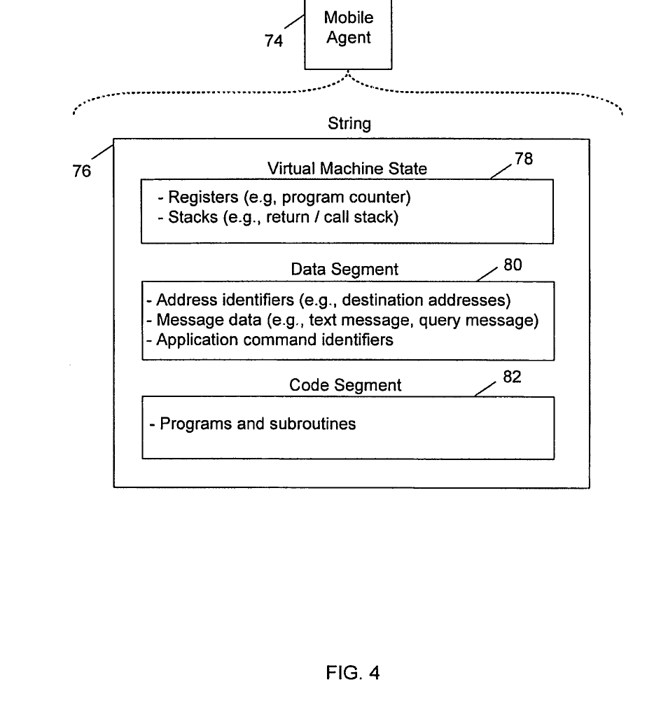

Referring to FIG. 4, a mobile agent 74 is presented to represent the contents of a typical mobile agent such as mobile agents 50-54. To store data, mobile agent 74 includes a string 76 (i.e., a series of consecutive characters) that is segmented to represent different information. One string segment 78 represents the current state of the virtual machine stored in mobile agent 74. Upon mobile agent 74 arriving at a device (e.g., computer system 34), string segment 78 is accessed to assist with interpreting and executing instructions on the device. In this example, the state of the virtual machine is represented by the content of registers (e.g., a program counter, etc.) and one or more stacks (e.g., return/call stack, etc.). By storing the content of register such as a program counter, the virtual machine retains the location to being executing instructions in a program or subroutine so that the recipient device (e.g., PDA 38) is aware of the location where processing was halted at another device (e.g., computer system 34).

String 76 also includes a string segment 80 that stores various data that is used in executing instructions and assisting in performing other operations. For example, data identifying one or more device addresses may be included in string segment 80. By storing device addresses (e.g., address of computer system 34, PDA 38, etc.) associated with a particular user, a logical sequence can be determined for delivering mobile agent 74. Textual (e.g., “Fire 15 Maple Court, Responding?”) and graphical data along with other data types (e.g., data structures, sound files) may also be included in string segment 80. Also, data associated with user-device interactions may be included. For example, a list of potential user responses (e.g., “Yes”, “No”, etc.), or other types of data associated with user interactions may be included. Additionally, graphical data (e.g., selection buttons, menus, etc.) may be included to assist with interfacing with a user. Textual data may also be included to assist with executing particular types of applications and executing operations associated with applications. For example, data may be included for executing application operations such as directing an Internet browser (e.g., Microsoft™ Internet Explorer™) to a particular website by including a uniform resource locator (URL) of the website in string segment 80.

To provide the recipient device with executable instructions, a string segment 82 is also included in string 70. Typically string segment 82 includes instructions from a compact programming language. In this example, bytecode instructions are used in programs and subroutines included in string segment 82. Bytecode is a type of programmable language that encodes instructions in single bytes so that an interpreter can relatively quickly determine the function or functions to execute. Due to their nature, some bytecode languages provide instructions that can be executed independent of platform type and are not tailored for executing on a specific type of device (e.g., computer system 34, PDA 38, cell phone 40, etc.). Furthermore, since the virtual machine state is transmitted with instructions in string 76, the current content of the virtual machine is used to assist in interpreting the bytecode instructions or to assist in compiling the bytecode for execution on the recipient device.

String 76 may also be processed prior to being inserted into mobile agent 74. For example, the entire string or part of the string may be compressed using a compression technique that is known by people skilled in the art. Typically, if string 76 is compressed, an interface engine such as engine 56 is capable of decompressing the string prior to extracting data. Also, to update a mobile agent, the interface engine may be capable of compressing a modified version of string 76 (or a portion of the string) for storing in the mobile agent.

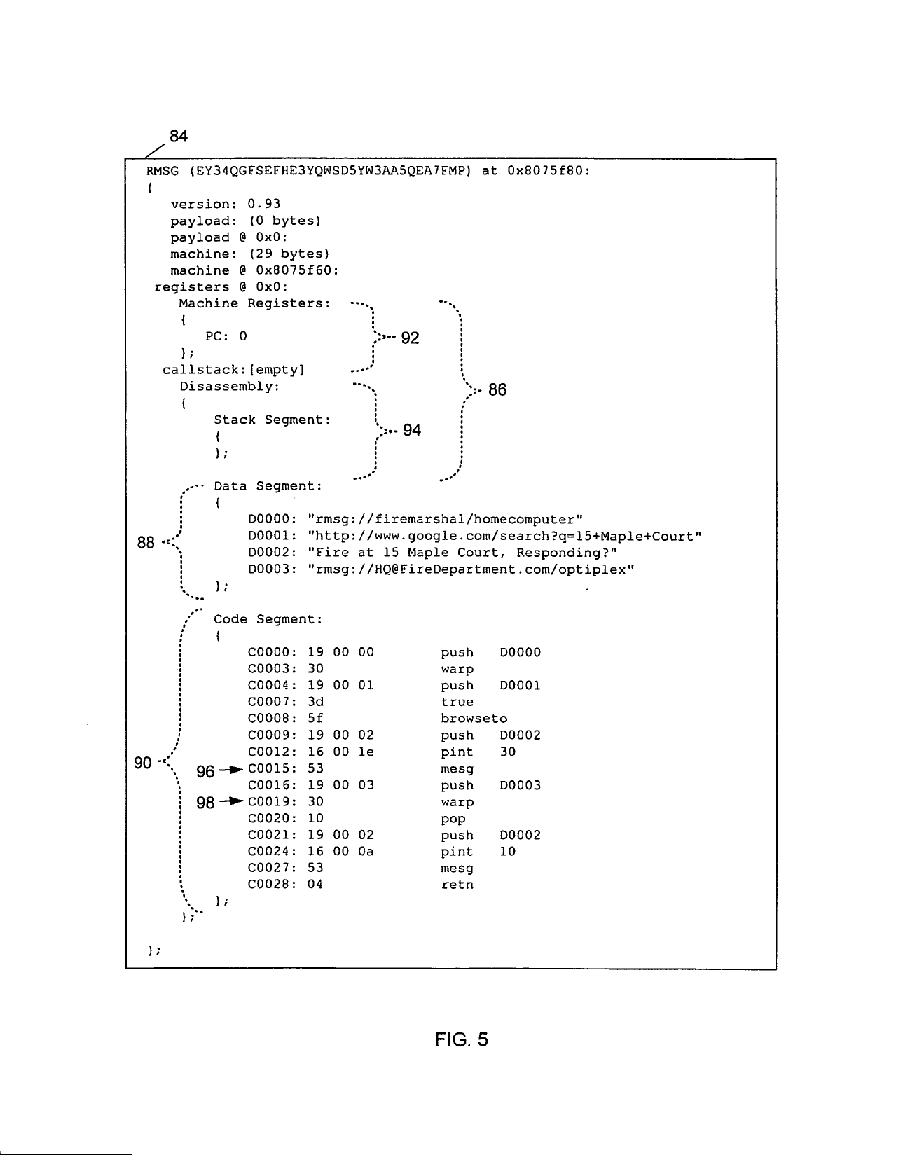

Referring to FIG. 5, a code listing 84 is presented that is exemplary of code included in a string such as string 76. In particular, code listing 84 includes a virtual machine section 86, a data section 88, and an instruction section 90. Virtual machine section 86 includes a structure 92 that includes the contents of each register in the virtual machine. In this example, structure 92 includes a variable (i.e., “PC”) that stores the contents of a program counter. This variable emulates the program counter in a central processing unit (CPU) that stores the address of the next instruction to be executed. By tracking the next instruction to be executed, as the mobile agent that stores code listing 84 moves about a communication system, the virtual machine identifies the next instruction to be executed after the agent is received by a recipient device. Along with register information, other information is included in virtual machine section 86. A structure 94 includes the content of stacks being used by the virtual machine. For example, a stack may be included in structure 94 for storing data used during bytecode instruction execution.

Data section 88 stores data that is used for a variety of operations and is placed into data registers for use during instruction execution. For example, data register D0000 and D0003 respectively contain addresses of destination computer systems. For example, data in register D0000 may represent the address of computer system 34 and data in register D0003 may represent the address of computer system 12. Data register D0001 stores a string of text for executing an operation (e.g., a “google” search) on an application (e.g., an Internet browser) resident at a recipient device. Again to execute the application, an interface engine residing at the recipient device locates and executes the particular application. Data stored in data register D0002 includes a textual message that is displayed on the recipient device when a particular bytecode instruction is executed.

Instruction segment 90 includes a listing ofbytecode instructions that when executed use data segment 88 and the current state of virtual machine 86. In this example, the bytecode instructions insert (“push”) data from data segment 88 onto a stack. Other bytecode instructions respectively access the stack to retrieve and use the stored data. For example, a bytecode instruction 96 (“mesg”) retrieves data (i.e., “Fire at 15 Maple Court, Responding?”) that is placed on the stack and presents the data on the device (e.g., computer system 34) that executes the instruction. If a user enters an input (e.g., selects “Yes” or “No”), data representing the user input is sent to another location (e.g., Fire Department headquarters) with another bytecode instruction (“warp”) 98. If a user input is not detected over a predetermined time period (e.g., the user is not near the device), a time out occurs and the mobile agent that stores code listing 84 is sent to another device for user input.

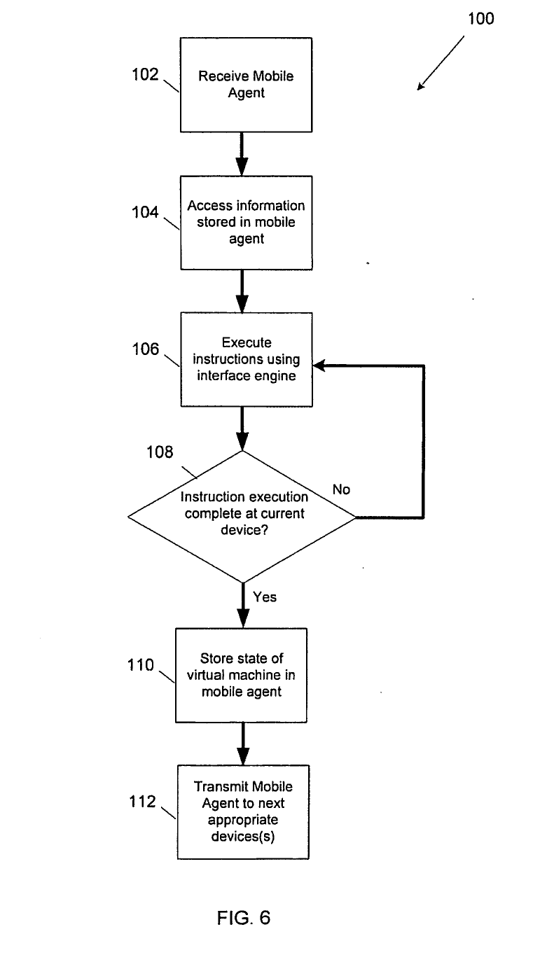

Referring to FIG. 6, a flow chart 100 represents individual and joint actions of a mobile agent (e.g., mobile agent 74) and a recipient device (e.g., computer system 34, PDA 38, cell phone 40, etc.) for executing one or more platform-independent instructions included in the mobile agent. Upon receiving 102 the mobile agent, the recipient device accesses 104 information stored in the mobile agent. As described, the mobile agent stores the state of a virtual machine along with data that identifies one or more instructions for executing on the recipient device. An interface engine (e.g., interface engine 62) that resides on the recipient device provides assistance to interpret and execute the instructions provided by the mobile agent. For example, by interrogating the capabilities of the recipient device, the interface engine provides access to the applications and data that reside on the recipient device.

As instructions are executed 106, the mobile agent monitors 108 for when instruction execution is complete on the recipient device. For example, if a time-out occurs, the mobile agent may determine that instruction execution is complete on the recipient device and the time has arrived to transfer to another device. Sometimes the mobile agent may determine to suspend instruction execution at the recipient device and temporarily move to another device (e.g., PDA 38) that is capable of performing a particular operation. For example, if PDA 38 includes a global position system (GPS) receiver, the mobile agent may temporarily transfer to this device to determine the GPS location of the PDA. Upon determining the GPS fix, the mobile agent may return to the original recipient device. Besides determining a device location, other information may be provided to a mobile agent. For example, external conditions (e.g., temperature, noise level, light level, etc.) may be provided by one or more sensors to the mobile agent. Information associated with a recipient device may also be provided to an agent, such as the model and serial number of the device or other information that identifies the device.

Once the mobile agent has determined that the execution of the appropriate instruction or instructions is complete, data is stored 110 in the mobile agent that represents an updated state of the virtual machine due to the instruction execution. For example, for each instruction executed, a program counter is incremented. To indicate the increased value of the program counter, the value is stored in the virtual machine. By updating the program counter (along with other registers and stacks represented in the virtual machine), the updated state of the virtual machine is stored in the mobile agent prior to it departing 112 to one or more other devices for further processing. By updating the state of the virtual machine, the mobile agent indicates which instructions have already been executed and do not need to be executed again at the next recipient device or devices.

A number of implementations have been described. Nevertheless, it will be understood that various modifications may be made. Accordingly, other implementations are within the scope of the following claims.

What is claimed is:

1. A method of executing programmable instructions, comprising the steps of:
receiving at a first device a mobile agent from a mobile agent dispatching device, wherein the mobile agent includes a state of a virtual machine; and
executing at the first device one or more instructions identified by the mobile agent, thereby changing the state of the virtual machine.

2. The method of claim 1, further comprising the step of:
sending the mobile agent to a second device; wherein the mobile agent represents the changed state of the virtual machine.

3. The method of claim 1, further comprising the step of:
sending the mobile agent to the mobile agent dispatching device, wherein the changed state of the virtual machine is represented in the mobile agent.

4. The method of claim 1, further comprising the step of:
sending the mobile agent to the second device when a timeout period expires, wherein the changed state of the virtual machine is represented in the mobile agent.

5. The method of claim 1, wherein executing the one or more instructions is delayed a period of time.

6. The method of claim 1, further comprising the step of:
sending the mobile agent to the mobile agent dispatching device and a copy of the mobile agent to a second device, wherein the changed state of the virtual machine is represented in the mobile agent and the copy of the mobile agent.

7. The method of claim 1, further comprising the step of:
inserting a string that identifies the changed state of the virtual machine into the mobile agent.

8. The method of claim 1, further comprising the step of:
compressing a string that identifies the changed state of the virtual machine; and
inserting the compressed string into the mobile agent.

9. The method of claim 2, wherein the mobile agent includes information that initiates sending the mobile agent from the first device to the second device.

10. The method of claim 1, wherein the mobile agent includes information that uniquely identifies the mobile agent.

11. The method of claim 1, further comprising the step of:
deleting a previously received mobile agent.

12. A system for executing programmable instructions, comprising:
a mobile agent dispatching device for sending a mobile agent to a first device, wherein the mobile agent includes a state of a virtual machine and one or more instructions that when executed at the first device change the state of the virtual machine.

13. The system of claim 12, further comprising:
a second device for receiving the mobile agent being sent from the first device, wherein the mobile agent received at the second device represents the changed state of the virtual machine.

14. The system of claim 12, wherein the mobile agent that represents the changed state of the virtual machine is sent from the first device to the mobile agent dispatching device.

15. The system of claim 13, wherein the mobile agent, which represents the changed state of the virtual machine, is sent to the second device when a timeout period expires.

16. The system of claim 13, wherein sending the mobile agent, which represents the changed state of the virtual machine, from the first device to the second device is delayed a period of time.

17. The system of claim 13, wherein the mobile agent, which represents the changed state of the virtual machine, is sent to the mobile agent dispatching device and the second device.

18. The system of claim 12, wherein the mobile agent dispatching device includes a computer system.

19. The system of claim 12, wherein the first device includes a computer system.

20. The system of claim 12, wherein the first device includes a personal digital assistant.

21. The system of claim 12, wherein the first device includes a cellular telephone.

22. The system of claim 12, wherein the mobile agent includes a string that represents the state of the virtual machine.

23. The system of claim 12, wherein the state of the virtual machine represents content of a register.

24. The system of claim 12, wherein the state of the virtual machine represents content of a stack.

25. The system of claim 12, wherein the mobile agent includes a string that represents a data segment.

26. The system of claim 12, wherein the mobile agent includes a string that represents a code segment.

27. The system of claim 12, wherein the mobile agent includes a string that includes bytecode instructions.

28. The system of claim 12, wherein the mobile agent includes a string that identifies a bytecode instruction to be executed on a second device.

29. The system of claim 13, wherein the mobile agent sent from the first device includes information associated with the first device.

30. The system of claim 29, wherein the information associated with the first device includes the location of the first device.

31. The system of claim 29, wherein the information associated with the first device includes an external condition associated with the first device.

32. The system of claim 29, wherein the information associated with the first device includes a description of the first device.

33. The system of claim 12, wherein the mobile agent includes information that uniquely identifies the mobile agent.

34. A computer program product residing on a computer readable medium having a plurality of instructions stored thereon which, when executed by a processor, cause the processor to:
receive at a first device a mobile agent from a mobile agent dispatching device, wherein the mobile agent includes a state of a virtual machine; and
execute at the first device one or more instructions identified by the mobile agent, thereby changing the state of the virtual machine.

35. The computer program product of claim 34, further comprising instructions for:
sending the mobile agent to a second device, wherein the mobile agent represents the changed state of the virtual machine.

36. The computer program product of claim 34, further comprising instructions for:
sending the mobile agent to the mobile agent dispatching device, wherein the changed state of the virtual machine is represented in the mobile agent.

37. The computer program product of claim 34, further comprising instructions for:
sending the mobile agent to the second device when a timeout period expires, wherein the changed state of the virtual machine is represented in the mobile agent.

38. The computer program product of claim 35, wherein sending the mobile agent to the second device is delayed a period of time at the first device.

39. The computer program product of claim 34, further comprising instructions for:
sending the mobile agent to the mobile agent dispatching device and a copy of the mobile agent to a second device, wherein the changed state of the virtual machine is represented in the mobile agent and the copy of the mobile agent.

40. The computer program product of claim 34, further comprising instructions for:
inserting a string that identifies the changed state of the virtual machine into the mobile agent.

41. The computer program product of claim 34, further comprising instructions for:
compressing a string that identifies the changed state of the virtual machine; and
inserting the compressed string into the mobile agent.

42. The computer program product of claim 35, wherein the mobile agent includes information that initiates sending the mobile agent from the first device to the second device.
